(19) United States
(12) Patent Application Publication
(10) Pub. No.: US 2019/0392138 A1
(43) Pub. Date: Dec. 26, 2019

(54) System and Method for Protecting Unknown Vulnerabilities in Smart Contracts

(71) Applicant: Bootstrap Legal Inc., LOS ANGELES, CA (US)

(72) Inventor: Dan Rice, LOS ANGELES, CA (US)

(73) Assignee: Bootstrap Legal Inc., LOS ANGELES, CA (US)

(21) Appl. No.: 16/198,058

(22) Filed: Nov. 21, 2018

Related U.S. Application Data
(63) Continuation-in-part of application No. 16/019,203, filed on Jun. 26, 2018.
Application No. 16/019,203 is a continuation-in-part of application No. 16/019,250, filed on Jun. 26, 2018.
Application No. 16/019,250 is a continuation-in-part of application No. 16/019,270, filed on Jun. 26, 2018.

(51) Int. Cl. G06F 21/54; G06F 21/12; G06F 21/56; G06Q 20/04; H04L 9/06

(52) U.S. Cl. CPC G06F 21/54; G06F 21/121; H04L 2209/38; G06Q 20/04; H04L 9/0637; G06F 21/563

(57) ABSTRACT

The invention relates to a system and method for injecting protection mechanisms into a smart contract code that may have unknown vulnerabilities. More specifically, the invention identifies key lines of code/commands that execute critical functions in a smart contract and injects additional code to monitor and prevent unwanted execution of said key lines of code/commands.

This application is a continuation-in-part and incorporates by reference U.S. patent application Ser. Nos. 16/019,270, 16/019,250 and 16/019,203.

### FIELD OF INVENTION

The invention relates to a system and method for injecting protection mechanisms into a smart contract code that may have unknown vulnerabilities. More specifically, the invention identifies key lines of code/commands that execute critical functions in a smart, contract and injects additional code to monitor and prevent unwanted execution of said key lines of code/commands.

### BACKGROUND OF INVENTION

In recent years, cryptocurrency and blockchain systems have grown in popularity with the introduction of smart contracts. The benefit of smart contracts is that they are programmed in code and will automatically execute. This takes the uncertainty out of many transactions and can potentially eliminate the need for costly middlemen. However, at the same time the self-executing nature of smart contracts makes errors in smart contract extremely costly. Once a transaction has been executed by a smart contract on a blockchain, it is extremely difficult, if not impossible, to reverse. However, despite the increased activity within the space, smart contracts are still very rudimentary and prone to error. In 2017 alone, over $1 billion USD was lost due to smart contract errors. Smart contracts are currently being programed at a very basic level and all necessary functionality must be programmed.

The problem is further complicated when using smart contracts on a blockchain. Blockchain systems have many benefits that make them very useful, however some of these characteristics also present challenges. One benefit of many blockchain systems is that they are immutable and permanent (some have varying levels of immutability). While this is extremely useful for creating a trustless ledger, this feature makes it difficult to use smart contracts on a blockchain because contracts often need to be amended, terminated, or disputed, prior to their execution; and sometimes after their execution. Additionally, the permanent nature of a financial transaction further heightens the need for tools to amend, terminate, or dispute a smart contract prior to its execution.

Furthermore, while there are audit firms and services that review smart contracts for potential vulnerabilities and errors, their services are not always effective. Indeed, many of the recent smart contracts that had losses were reviewed by audit firms. Accordingly, there exists a need for a system and method to protect smart contracts from vulnerabilities and inject useful tools for managing smart contract execution.

### SUMMARY OF INVENTION

While smart contracts can be programmed with nearly endless complexity and functionality, the crucial functions that may have irreversible negative impact such as transferring funds are limited. Accordingly, the system and method of the invention identifies these critical functions in any smart contract and inserts a software development kit “SDK”, described in patent U.S. patent application Ser. Nos. 16/019,270, 16/019,250 and 16/019,203 which contains functionality for dispute resolution selection, monitoring, managing control and access to smart contract, freeze, modify, terminate, trigger disputes, communicate with contracting parties, and resolve disputes. With the injection of the SDK toolkit and proper use of its tools, nearly all smart contract vulnerabilities can be eliminated. Below is a brief summary of the system and method in accordance with an embodiment of the present invention:

### Configuring Step

In one embodiment, the present invention provides a Graphic User Interface (GUI) that allows users to identify a smart contract that has already been compiled but not recorded on a blockchain.

The GUI then provides the user with a plurality of options for selecting features in the SDK related to dispute resolution selection, monitoring, managing control and access to smart contract, governance rules and permissions, freeze, modify, delay timing of execution, terminate, trigger disputes, communicate with contracting parties, and resolve disputes.

### Injection Step

In one embodiment of the present invention, the system locates the smart contract code (that has already been compiled into binary) identified by the user and converts the binary blob to assembly (“ASM”) code using a disassembler.

The system then injects SDK functions into the code based on the user's selection of features and functionality in the configuring step.

Finally, the system searches the ASM code for critical functions or operation codes and injects additional safety code. Functions that require safety code injection can include any function that adjusts balances as well as functions that modify smart contract access permissions.

Critical functions/operation code search can be isolated specifically to codes that send money, modify smart contract state variables, or send events.

### LIST OF INJECTIONS

Dispute resolution system state variable construction

Allocate state variables

Dispute resolution system state variable values

Set initial values for allocated state variables

Dispute resolution mode freeze code

Dispute resolution activation and permission adjustment functions

Contract upgrade code

Delayed transaction queuing code

Dispute resolver admin control function

Self resolution logic

In one embodiment, the present invention is implemented as downloadable software that is installed at the user's computer.

In some embodiments, instead of injecting complete SDK code into the smart contract, the system may inject only a portion of code that references an external smart contract that contains the SDK code. Below is a list of some SDK components that can be implemented as an external smart contract:

Delayed Transaction Queue

Self resolution logic

Dispute resolution

Escrow of dispute resolution payment
Appeals
Payment

### BRIEF DESCRIPTION OF DRAWINGS

Preferred embodiments of the present invention are described with reference to the following drawings, wherein:

FIG. 1 depicts smart contract SDK injection system in accordance with an embodiment of the present invention; and

FIG. 2 depicts the smart contract SDK injection system implemented as a local client injection tool that injects links to external SDK components.

### DETAILED DESCRIPTION

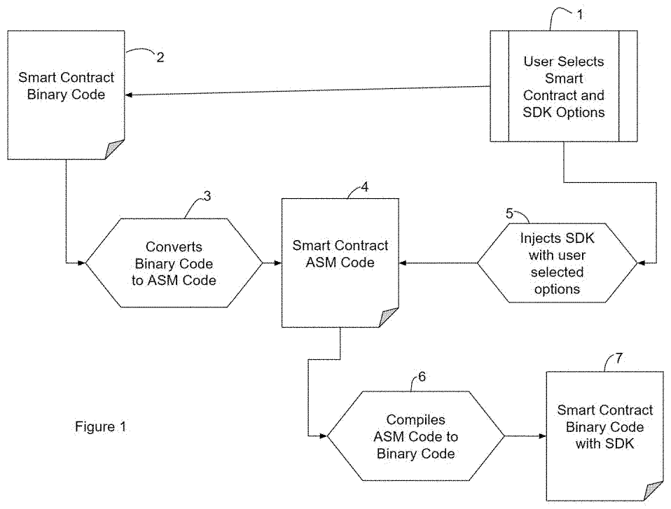

Described herein is a system and method for protecting an unknown smart contract from errors and vulnerabilities that would cause it to operate unexpectedly by locating key operation codes within the smart contract and injecting certain protection mechanisms in the form of an SDK or links to external SDK smart contract components. This system and method provides many benefits because it does not require that the user have any specific knowledge of the smart contract code. Thus, anyone that wants to add additional features to a smart contract can do so quickly and efficiently without having to review the original smart contract code. FIG. 1 is a diagram that shows the system in accordance with an embodiment of the present invention. The system is implemented using a GUI 1 that presents the user with easy to use options that can be easily selected/configured and does not require specialized knowledge or training. First, the user selects smart contract code that they wish to safeguard using, the GUI 1. The user then selects some or all of the smart contract SDK features they wish to implement into the selected smart contract from a list, displayed by the GUI 1. Next, the system locates the smart contract 2 selected by the user which can be compiled binary code. The system then takes the smart contract binary code 2 and converts it using a disassembler 3 into smart contract ASM code 4. The system then uses an injection tool 5 to input the smart contract SDK features that the user selected into the smart contract ASM code 4. Next the smart contract ASM code with SDK features is then sent to a compiler 6 which compiles the ASM code to generate the final smart contract binary code with SDK features 7. The code is then ready to be recorded on a blockchain for execution.

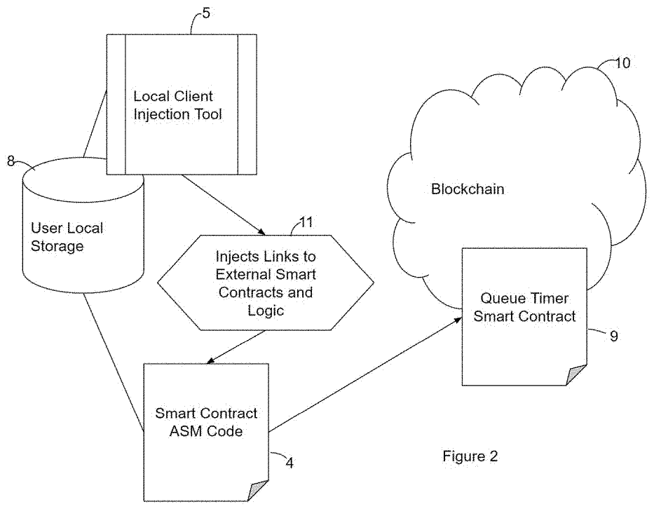

FIG. 2 is a diagram that shows the system in accordance with an embodiment of the present invention which the system is implemented as a local client injection tool that is installed in the user's computer in the user's local storage 8. However, it should be understood that the system can be implemented as a web page, dapp, or mobile app. Additionally, FIG. 2 also shows a system that injects links to external smart contracts, and more specifically, a smart contract queue timer which delays the execution of certain functions using a queue timer. One benefit of using links is that it allows for smart contracts and the SDK components to be upgraded or amended more easily by simply revising or editing the external smart contracts'SDK components. The system functions much like the embodiment depicted in FIG. 1, however instead of injection entire SDK code components, the injection tool 5 injects code with links 11 that point to an external smart contract 9 that is stored on a blockchain 10.

The system is able to efficiently locate and inject relevant protective code because the list of critical functions/operational code that would have an adverse and material impact on the smart contract is relatively small and can be easily identified. These critical functions related to smart contracts direct the smart contract to alter the state of the smart contract, send funds, or calls external functions. Below is a list of a few examples of critical functions/operational code that would be identified by the injection tool for Ethereum (a blockchain and smart contract platform):

SSTORE—Writes to data storage

DELEGATECALL—Calls arbitrary code in external function

CALL—Can send ETH to another address

While Ethereum is disclosed in this description, it should be understood that this invention can be used with any smart contract platform.

Accordingly, the injection tool 5 has a list of critical functions/operational code that would correspond to each smart contract SDK component that is selected by the user. For each selected smart contract SDK component selected by the user, the injection tool 5 performs the following logic (variable “A” is being used as a placeholder for any of the SDK components mentioned above):
1. User selects SDK component A and parameters;
2. Injection tool identifies and locates op code(s) related to SDK component A with selected parameters; and
3. Injection tool injects SDK component A with selected parameters to each identified location.

Additionally and alternatively, the system may inject the SDK component A (and parameters) to an endpoint or inject external link to SDK component. A.

Below is an example of the logic and injection for the smart contract freeze feature.

Original code:

SSTORE

New code:

Add to delay queue (SSTORE: parameters, time delay)

Pseudocode for contract freeze (injected at start of program code):

If (sender is DR vendor)
Continue

Else if ((DRMode active is true) AND (Function called is not an injected governance function))
Quit

Else
Continue

### LIST OF INJECTIONS

Dispute Resolution System State Variable Construction

### Pseudocode:

Allocate state variables

Dispute Resolution System State Variable Values

### Pseudocode:

Set initial values for allocated state variables

Dispute Resolution Mode Freeze Code

Freeze function goes at top (does not require wrapper/ob code like others)

### Pseudocode:

Contract dispute and freeze function called
If DRMode variable is false

Set DRMode variable to true

Dispute Resolution Activation

### Pseudocode:

Dispute activation mode function called
If the user is authorized to start dispute mode and has enough weight to cross threshold

Start dispute resolution mode (freeze public functions)

Start clock on self resolution timeout.

Else if user is authorized but does not have enough weight

Add user's weight to cumulative weight threshold

Governance

### Pseudocode:

Smart contract publish transaction pushes constructor code to network
Constructor code runs which defines the initial list of members for the dispute activation list and threshold parameters for altering the list
Request is made to add or remove member of dispute activation list
Does requesting user have the needed permission level to perform action?

Add/remove user

Contract Upgrade Code

### Pseudocode:

New contract published to network
Contract switch code published to network
Contract switch code address sent as delegate call to main smart contract
Contract calls switch code address which changes the proxy address in local state

Delayed Transaction Queuing Code

### Pseudocode:

### Delay

Transaction delay called
Store transaction sender and deferred action with unique ID
Send after delay
Deferred send called with unique ID
Does transaction sender match record and expiration delay time elapsed?

Send action

Clear deferred transaction from state

Dispute Resolver Admin Control Function

### Pseudocode:

DR party follows proof-of-intent process to create self resolution proposal contract
DR party submits self-resolution proposal with a contract address and function
Other approved DR participants vote yes or no on proposal
if (vote unanimous yes)

code is executed

else

end self dispute mode

enable dispute resolution vendor access

In addition to the smart contract SDK components (list of injections) list above, any or all of the SDK components disclosed in parent application Ser. Nos. 16/019,270, 16/019,250 and 16/019,203 can be used. Furthermore, a smart contract monitoring system disclosed in the '270, '250, and '203 patents may also be used with the SDK components to provide additional safeguards to prevent unexpected execution of smart contract.

There are smart contract scripting languages that do not require compiling into binary. For smart contracts that use scripting language, the invention can still be used without the need for the disassembly step. The system can simply take the smart contract code and identify critical functions/operational code and inject SDK components. Once the system has finished injecting SDK components, the smart contract can be compiled into binary and recorded to blockchain for use. Alternatively, in systems where binary code is not necessary, the smart contract can be recorded to blockchain for execution.

1. One or more storage devices storing instructions that are executable to perform operations comprising:
locating smart contract code that has been compiled into binary;
using a disassembler to convert at least a portion of the binary smart contract code into assembly language;
searching the assembly language for at least one critical function; and
inject at least one set of code to modify the operation of the critical function.

2. The one or more storage devices of claim 1 wherein the critical function is at least one of: send money or cryptocurrency, modify smart contract state variables, or set events.

3. The one or more storage devices of claim 1 wherein the set of code is a software development kit.

4. The one or more storage devices of claim 1 wherein the set of code is at least one of: dispute resolution state variables; smart contract freeze code; dispute resolution activation and permission adjustment functions; contract upgrade code; delayed transaction queuing code; dispute resolver admin control function; or self resolution logic.

5. The one or more storage devices of claim 1 wherein the code to modify the operation of the critical function is a link to an external smart contract

6. One or more storage devices storing instructions that are executable to perform operations comprising:
locating smart contract code;
searching smart contract code for a critical function; and
inject at least one set of code to modify the operation of the critical function.

7. The one or more storage devices of claim 6 further comprising:
searching smart contract code for a second critical function; and
inject a second set of code to modify the operation of the second critical function.

8. The one or more storage devices of claim 6 where in the critical unction is a function that sends money or cryptocurrency.

9. The one or more storage devices of claim 8 wherein the at least one set of code is smart contract code that delays or freezes the send money or cryptocurrency critical function.

10. The one or more storage devices of claim 6 further comprising:
recording the smart contract on a blockchain for execution.

11. The one or more storage devices of claim 1 further comprising:
recording the smart contract on a blockchain for execution.

12. The one or more storage devices of claim 3 wherein the software development kit contains at least a freeze or delay function.

13. A method for protecting smart contract from unknown vulnerabilities comprising:
identifying smart contract code;
searching smart contract code for a first critical function; and
inject at least one set of code to modify the operation of the first critical function.

14. The method of claim 13 further comprising:
searching smart contract code for a second critical function; and
inject a second set of code to modify the operation of the second critical function.

15. The method of claim 13 further comprising:
recording the smart contract with modified code onto a blockchain.

16. The method of claim 13 further comprising:
recording the smart contract with modified code on a distributed ledger.
